(19) United States
(12) Patent Application Publication
(10) Pub. No.: US 2016/0182520 A1
(43) Pub. Date: Jun. 23, 2016

(54) METHOD, APPARATUS AND SYSTEM FOR CLIENT ACCESSING AUTHENTICATED WEB ADDRESS

(71) Applicant: BEIJING QIHOO TECHNOLOGY COMPANY LIMITED, Beijing (CN)

(72) Inventor: Fuqiang LIU, Beijing (CN)

(73) Assignee: BEIJING QIHOO TECHNOLOGY COMPANY LIMITED, Beijing (CN)

(21) Appl. No.: 14/907,466

(22) PCT Filed: Jul. 11, 2014
(86) PCT No.: PCT/CN2014/082086

§ 371 Date: Jan. 25, 2016

(30) Foreign Application Priority Data
Jul. 26, 2013 (CN) 201310319672.4
Jul. 26, 2013 (CN) 201310320872.1

(51) Int. Cl. H04L 29/06; G06F 17/30

(52) U.S. Cl. CPC H04L 63/10; H04L 63/08; G06F 17/30864; G06F 17/30876

(57) ABSTRACT

The invention discloses a method, an apparatus and a system for a client accessing an authenticated web address. The method comprises: automatically querying a server or a database whether there is an authenticated website matching entry corresponding to all keywords that the client already has, when it is detected that a user enters one or more characters to the client each time; obtaining a web address link corresponding to the authenticated website matching entry from the server or the database, and displaying an interface element corresponding to the web address link at a predetermined position of the client, if the corresponding authenticated website matching entry is found out; and when detected that the user triggers the interface element, accessing the authenticated website corresponding to the web address link. The invention reduces the time spent by a user in searching for an official website and provides a faster channel for the user.

### FIELD OF THE INVENTION

The invention relates to the field of internet communications, and in particular, to a method, an apparatus and a system for a client accessing an authenticated web address.

### BACKGROUND OF THE INVENTION

In the existing technologies, if a user wants to view a certain website, but does not know the official website address of the website, the user will enter a keyword about the website in a search bar to search for some websites via the search bar. For example, FIG. 1 is a schematic diagram of a user searching via a search bar in the existing technologies. As shown in FIG. 1, when the user searches the Taobao website, he will enter an official website keyword “taobao” in the search bar. Before the user clicks a search button, a suggested list of keywords will appear in a drop-down menu. After the user clicks the search button, as shown in FIG. 2, a link to the “Taobao website” will be found in a list of search results.

It can be seen from the above processing procedure that, when the user is searching for a very definite official web address keyword, the processing way of the search engine is identical to that of a common keyword, which can not well approximate the direct intention of the user, resulting in that the user wastes a lot of time when searching for an official web address.

### SUMMARY OF THE INVENTION

In view of the above problems, the invention is proposed to provide a method, an apparatus and a system for a client accessing an authenticated web address to overcome the above problems or at least partly solve the above problems.

According to an aspect of the invention, the invention provides a method for a client accessing an authenticated web address, which comprises:

automatically querying a server or a database whether there is an authenticated website matching entry corresponding to all keywords that the client already has, when it is detected that a user enters one or more characters to the client each time;

obtaining a web address link corresponding to the authenticated website matching entry from the server or the database, and displaying an interface element corresponding to the web address link at a predetermined position of the client, if the corresponding authenticated website matching entry is found out; and

when it is detected that the user triggers the interface element, accessing the authenticated website corresponding to the web address link.

Optionally, when a character is entered via a search bar of the client,

the automatically querying a server or a database whether there is an authenticated website matching entry corresponding to all keywords that the client already has when it is detected that a user enters one or more characters to the client each time comprises: automatically querying a search engine server whether there is an authenticated website matching entry corresponding to all keywords that already exist in the search bar when it is detected that the user enters one or more characters to the search bar each time; and

the obtaining a web address link corresponding to the authenticated website matching entry from the server or the database, and displaying an interface element corresponding to the web address link at a predetermined position of the client, if the corresponding authenticated website matching entry is found out comprises: if a web address link corresponding to the authenticated website matching entry fed back by the search engine server is received, displaying an interface element corresponding to the web address link at a predetermined position of the search bar.

Optionally, when a character is entered via a browser address bar of the client,

the automatically querying a server or a database whether there is an authenticated website matching entry corresponding to all keywords that the client already has when it is detected that a user enters one or more characters to the client each time comprises: querying an authenticated web address database whether there is an authenticated website matching entry corresponding to all keywords that already exist in the browser address bar when it is detected that the user enters one or more characters to the browser address bar each time; and

the obtaining a web address link corresponding to the authenticated website matching entry from the server or the database, and displaying an interface element corresponding to the web address link at a predetermined position of the client, if the corresponding authenticated website matching entry is found out, comprises: if the corresponding authenticated website matching entry is found out, obtaining a web address link corresponding to the authenticated website matching entry from the authenticated web address database, and displaying an interface element corresponding to the web address link at a predetermined position of the browser address bar.

According to another aspect of the invention, the invention further provides an apparatus for a client accessing an authenticated web address, configured to implement the above method for a client accessing an authenticated web address.

According to a further aspect of the invention, the invention further provides a system for accessing an authenticated web address via a search bar, which comprises an apparatus for a client accessing an authenticated web address described above, and further comprises a search engine server configured to, according to a request from the apparatus, query whether there is a web address link corresponding to all keywords that already exist in the search bar and feed it back to the apparatus.

According to yet another aspect of the invention, there is provided a computer program comprising a computer readable code which causes a computing device to perform any of the methods for a client accessing an authenticated web address described above, when said computer readable code is running on the computing device.

According to still another aspect of the invention, there is provided a computer readable medium storing therein the computer program as described above for performing a method for a client accessing an authenticated web address.

The beneficial effects of the invention are as follows:

by means of the technical solutions of embodiments of the invention, each time after a user enters a character to a search bar or a browser address bar, and after it is automatically found out that there is an authenticated website matching entry corresponding to all keywords entered by the user, an interface element corresponding to a corresponding web address link is displayed to the user, which reduces the time spent by the user in searching for an official website and provides a fast channel for arriving at the authenticated official website for the user.

The above description is merely an overview of the technical solutions of the invention. In the following particular embodiments of the invention will be illustrated in order that the technical means of the invention can be more clearly understood and thus may be embodied according to the content of the specification, and that the foregoing and other objects, features and advantages of the invention can be more apparent.

### BRIEF DESCRIPTION OF THE DRAWINGS

Various other advantages and benefits will become apparent to those of ordinary skills in the art by reading the following detailed description of the preferred embodiments. The drawings are only for the purpose of showing the preferred embodiments, and are not considered to be limiting to the invention. And throughout the drawings, like reference signs are used to denote like components. In the drawings:

FIG. 1 is a schematic diagram of a user searching via a search bar in the existing technologies;

FIG. 2 is a schematic diagram of a result of a user searching via the search bar in the existing technologies;

FIG. 3 is a flow chart of a method for accessing an authenticated web address via a search bar in an embodiment of the invention;

FIG. 4 is a schematic diagram of a user entering a word “tao” in an embodiment of the invention;

FIG. 5 is a schematic diagram of a search result of Example One in an embodiment of the invention;

FIG. 6 is a schematic diagram of a user entering a letter “t” via a search bar in an embodiment of the invention;

FIG. 7 is a schematic diagram of a search result of Example Three in an embodiment of the invention;

FIG. 8 is a structural diagram of an apparatus and a system for accessing an authenticated web address via a search bar in an embodiment of the invention;

FIG. 9 is a flow chart of a method for accessing an authenticated web address via a browser address bar in an embodiment of the invention;

FIG. 10 is a schematic diagram of a user entering a word “tao” in an embodiment of the invention;

FIG. 11 is a schematic diagram of a search result of Example Four in an embodiment of the invention;

FIG. 12 is a schematic diagram of a user entering a letter “t” via a browser address bar in an embodiment of the invention;

FIG. 13 is a schematic diagram of a search result of Example Six in an embodiment of the invention;

FIG. 14 is a structural diagram of an apparatus for accessing an authenticated web address via a browser address bar in an embodiment of the invention;

FIG. 15 shows schematically a block diagram of a computing device for performing a method for a client accessing an authenticated web address according to the invention; and

FIG. 16 shows schematically a storage unit for retaining or carrying a program code implementing a method for a client accessing an authenticated web address according to the invention.

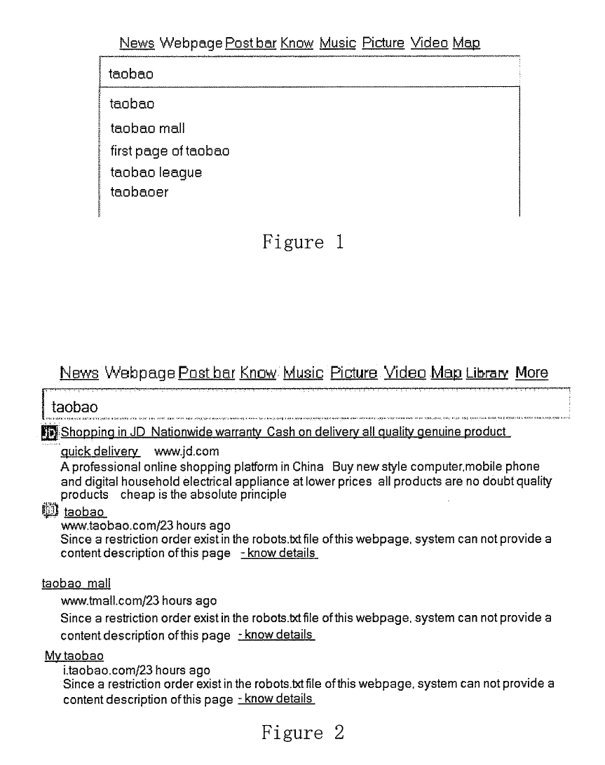

### DETAILED DESCRIPTION OF THE INVENTION

In the following the invention will be further described in connection with the drawings and the particular embodiments.

In order to solve the above problems in the traditional art, the invention provides a method, an apparatus and a system for a client accessing an authenticated web address, and in the following, the invention will be further described in detail in connection with the drawings and the embodiments. It should be understood that the particular embodiments described herein are only used for explaining the invention, and do not define the invention.

To solve the above technical problems, an embodiment of the invention provides a method for a client accessing an authenticated web address. The method comprises the following steps:

automatically querying a server or a database whether there is an authenticated website matching entry corresponding to all keywords that the client already has when it is detected that a user enters one or more characters to the client each time;

obtaining a web address link corresponding to the authenticated website matching entry from the server or the database, and displaying an interface element corresponding to the web address link at a predetermined position of the client, if the corresponding authenticated website matching entry is found out; and

when it is detected that the user triggers the interface element, accessing the authenticated website corresponding to the web address link.

The client may enter a character via multiple entrances, for example, a search bar, a browser address bar, etc.

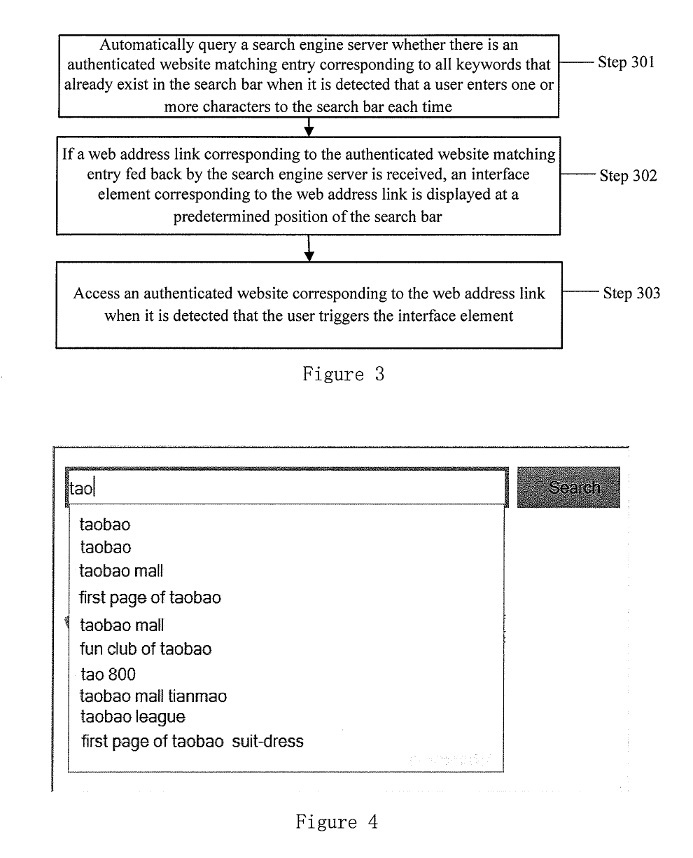

According to an embodiment of the invention, there is provided a method for accessing an authenticated web address via a search bar. FIG. 3 is a flow chart of a method for accessing an authenticated web address via a search bar in an embodiment of the invention. As shown in FIG. 3, the method for accessing an authenticated web address via a search bar comprises the following processing.

At step 301, a search engine server is automatically queried whether there is an authenticated website matching entry corresponding to all keywords existing in the search bar when it is detected that a user enters one or more characters to the search bar each time.

For example, after the user enters a word “tao”, the search engine server is automatically queried whether there is an authenticated website matching entry corresponding to the word “tao”, and if no, and it is detected that the user further enters a word “bao”, then the search engine server is automatically queried whether there is an authenticated website matching entry corresponding to “taobao”.

Step 301 specifically comprises the following processing:

1. sending all keywords that already exist in the search bar to the search engine server by invoking a preset application programming interface (API for short);

2. the search engine server querying whether there is an authenticated website matching entry matching all the keywords that already exist in the search bar in a pre-configured correspondence relationship table, and if no, feeding back a message that there is no authenticated website matching entry; and if yes, obtaining a web address link in the authenticated website matching entry and feeding it back, wherein the correspondence relationship table comprises keywords, and web address links corresponding to the keywords.

At step 302, if a web address link corresponding to the authenticated website matching entry fed back by the search engine server is received, an interface element corresponding to the web address link is displayed at a predetermined position of the search bar. In an embodiment of the invention, the predetermined position comprises: the last position in the search bar.

Preferably, in an embodiment of the invention, if website identification information returned by the search engine server is further received, then when displaying the interface element corresponding to the web address link at the predetermined position of the search bar, the interface element corresponding to the web address link can be displayed at the predetermined position of the search bar according to the website identification information.

At step 303, when it is detected that the user triggers the interface element, an authenticated website corresponding to the web address link is accessed.

In the following, the above-described technical solution of embodiments of the invention will be exemplified in connection with the drawings.

### Example One

### The Keyword is “Taobao”

At step 1, as shown in FIG. 4, after it is detected that the user enters a first keyword “tao”, a preset backend API is invoked (namely, the keyword is query-converted into a query URL to be sent to the server side server: “http://zhidasug.www.so.com) to query a URL: http://zhidasug.www.so.com/?q=%E6%B7%98 (namely, http://zhidasug.www.so.com/?q=tao);

At step 2, the database at the server side does not find a match entry corresponding to the keyword “tao”, and therefore the returned jsonp informs a tip that there is no direct access, that is, the returned data is empty: zhida_sug([ ]);

At step 3, after it is detected that the user enters a second character which combines a keyword “taobao”, a backend API is invoked to send the keyword “taobao” to the server side, and the server side searches for a corresponding matching entry according to the correspondence relationship table, wherein the correspondence relationship table is as shown in table 1;

TABLE 1

| No. | HOST | URL | Copywriter | Query |
|---|---|---|---|---|
| 1 | Taobao.com | http://www.taobao.com/ | Taobao | Taobao, Taobaowang, |
| | | | | taobao, taobaowang |
| 2 | 360.cn | http://www.360.cn | 360 | 360, qihoo |
| 3 | Tmall.com | http://www.Tmall.com | Tmall | tianmaoshangcheng, |
| | | | | tianmao, tmall |

At step 4, after searching the correspondence relationship table, the jsonp data packet returned by the server side is zhida_sug([{“u”:“http://www.tmall.com/”,“n”:“u5929\u732b”}]), wherein u represents a direct access url, n represents a copywriter, i.e., displayed name; and taking the keyword “taobao” as an example, the returned jsonp data packet is:

zhida_sug(
[
{
u: “http://www.taobao.com/”,
n: “taobao”
}
]
)

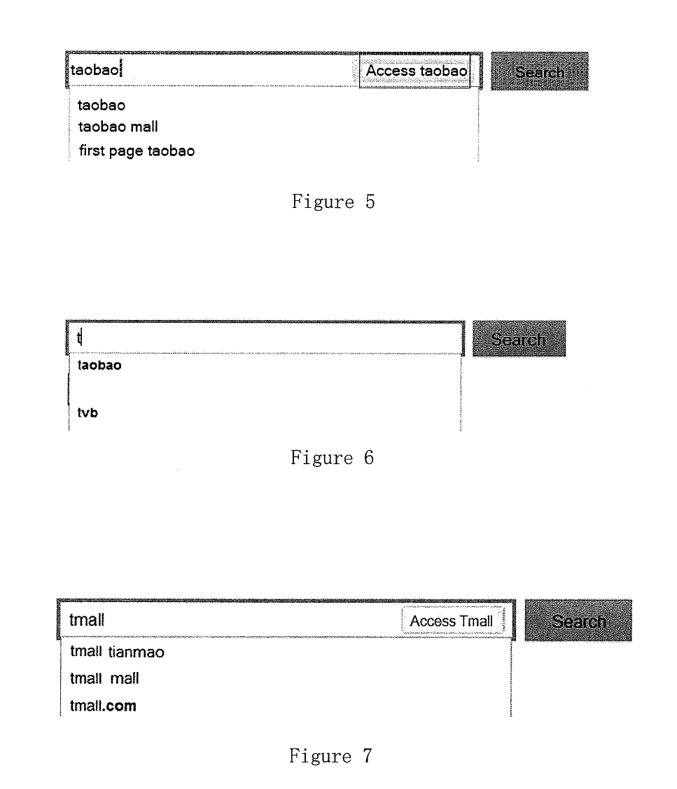

At step 5, as shown in FIG. 5, at this point, a button for direct access is shown at the last position in the search bar, and the form of the button is “access <n>”, wherein n is a copywriter, namely, the displayed name “taobao”.

### Example Two

### The Keyword is “Taobao”

At step 1, as shown in FIG. 6, after it is detected that the user enters a first English key letter “t”, a preset backend API is invoked (namely, the key letter is query-converted into a query URL to be sent to the server side server: “http://zhidasug.www.so.com) to query a URL: http://zhidasug.www.so.com/?q=t;

At step 2, the database at the server side does not find a match entry corresponding to the key letter “t”, and therefore the returned jsonp informs a tip that there is no direct access, that is, the returned data is empty: zhida_sug([ ]);

At step 3, after it is detected that the user enters a second character which combines a keyword “ta”, the backend API is invoked to query a URL, the result fed back by the server side at this time is identical to the previous step, and is still empty, until it is detected that the user enters “taobao”, the backend API is invoked to send the keyword “taobao” to the server side, the server side searches for a corresponding matching entry according to the correspondence relationship table as shown in table 1, and the returned jsonp data packet is zhida_sug([{“u”:“http://www.taobao.com/”,“n”:“u5929\u732b”}]), wherein u represents a direct access url, n represents a copywriter, i.e., displayed name. Taking the keyword “taobao” as an example, the returned jsonp data packet is:

zhida_sug(
[
- {
u: “http://www.taobao.com/”,
n: “taobao”
}
]
)

At step 4, at this point, a button for direct access is shown at the last position in the search bar, and the form of the button is “access <n>”, wherein n is a copywriter, namely, the displayed name “taobao”.

### Example Three

### The Keyword is “Tmall”

At step 1, as shown in FIG. 6, after it is detected that the user enters a first English key letter “t”, a preset backend API is invoked (namely, the key letter is query-converted into a query URL to be sent to the server side server: “http://zhidasug.www.so.com) to query a URL: http://zhidasug.www.so.com/?q=t;

At step 2, the database at the server side does not find a match entry corresponding to the query “t”, and therefore the returned jsonp informs a tip that there is no direct access, that is, the returned data is empty: zhida_sug([ ]);

At step 3, after it is detected that the user enters a second character which combines a keyword “tm”, the backend API is invoked to query a URL, the result fed back by the server side at this time is identical to the previous step, and is still empty, until it is detected that the user enters “tmall”, the backend API is invoked to send the keyword “tmall” to the server side, the server side searches for a corresponding matching entry according to the correspondence relationship table as shown in table 1, and the returned jsonp data packet is zhida_sug([{“u”:“http://www.taobao.com/”,“n”:“u5929\u732b”}]), wherein u represents a direct access url, n represents a copywriter, i.e., displayed name. Taking the keyword “tmall” as an example, the returned jsonp data packet is:

zhida_sug(
[
- {
u: “http://www. tmall.com/”,
n: “ tmall ”
}
]
)

At step 4, as shown in FIG. 7, at this point, a button for direct access is shown at the last position in the search bar, and the form of the button is “access <n>”, wherein n is a copywriter, namely, the displayed name “tianmao”.

In summary, by means of the technical solutions of embodiments of the invention, after it is automatically found out that there is an authenticated website matching entry corresponding to all keywords entered by the user, an interface element corresponding to a corresponding web address link is displayed to the user, which reduces the time spent by the user in searching for an official website and provides a fast channel for accessing the authenticated official website for the user.

Based on the same inventive concept, an embodiment of the invention further provides an apparatus for a client accessing an authenticated web address, configured to implement the above method for a client accessing an authenticated web address.

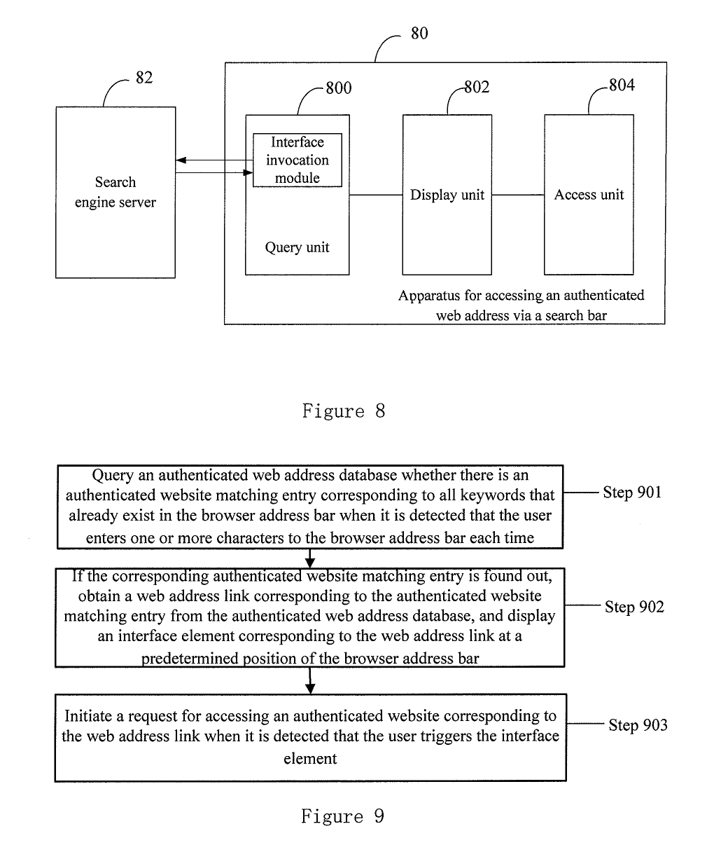

According to an embodiment of the invention, there is further provided an apparatus for accessing an authenticated web address via a search bar. FIG. 8 is a structural diagram of an apparatus and a system for accessing an authenticated web address via a search bar in an embodiment of the invention. As shown in FIG. 8, the apparatus 80 for accessing an authenticated web address via a search bar comprises: a query unit 800, a display unit 802 and an access unit 804, and in the following, each module of the embodiment of the invention will be described in detail.

The query unit 800 is configured to automatically query a search engine server whether there is an authenticated website matching entry corresponding to all keywords that already exist in the search bar when it is detected that a user enters one or more characters to the search bar.

The query unit 800 specifically comprises: an interface invocation module configured to send all keywords that already exist in the search bar to the search engine server by invoking a preset application programming interface API.

The display unit 802 is configured to, after a web address link corresponding to the authenticated website matching entry fed back by the search engine server is received, display an interface element corresponding to the web address link at a predetermined position of the search bar.

The display unit 802 is further configured to receive website identification information returned by the search engine server.

The display unit 802 is specifically configured to display the interface element corresponding to the web address link at the predetermined position of the search bar according to the website identification information.

In an embodiment of the invention, the predetermined position comprises: the last position in the search bar.

The access unit 804 is configured to access an authenticated website corresponding to the web address link when it is detected that the user triggers the interface element.

The specific processing of each module in the embodiment of the invention can be understood with reference to the description in the above method embodiment, and will not be repeated here.

According to an embodiment of the invention, there is further provided a system for accessing an authenticated web address via a search bar. As shown in FIG. 8, the system for accessing an authenticated web address via a search bar according to the embodiment of the invention comprises: an apparatus 80 for accessing an authenticated web address via a search bar described above and a search engine server 82. In the following, each apparatus of the embodiment of the invention will be described in detail.

The apparatus 80 for accessing an authenticated web address via a search bar has already been described in the above embodiment, and will not be repeated here.

The search engine server 82 is configured to, according to a request from the apparatus, query whether there is a web address link corresponding to all keywords that already exist in the search bar and feed it back to the apparatus.

The search engine server 82 is specifically configured to query whether there is an authenticated website matching entry matching all the keywords that already exist in the search bar in a pre-configured correspondence relationship table, and if no, feed back a message that there is no authenticated website matching entry; and if yes, obtain a web address link in the authenticated website matching entry and feed it back, wherein the correspondence relationship table comprises keywords, and web address links corresponding to the keywords.

Preferably, in an embodiment of the invention, the search engine server 82 may further obtain website identification information in the authenticated website matching entry and feed it back.

In summary, by means of the technical solutions of embodiments of the invention, each time after a user enters a character to a search bar, and after it is automatically found out that there is an authenticated website matching entry corresponding to all keywords entered by the user, an interface element corresponding to a corresponding web address link is displayed to the user, which reduces the time spent by the user in searching for an official website and provides a fast channel for accessing the authenticated official website for the user.

To solve the above problems in the traditional art, the invention further provides a method and an apparatus for accessing an authenticated web address via a browser address bar, and in the following, the invention will be further described in detail in connection with the drawings and embodiments. It should be understood that specific embodiments described here are only used to explain the invention, but not define the invention.

According to an embodiment of the invention, there is further provided a method for accessing an authenticated web address via a browser address bar. FIG. 9 is a flow chart of a method for accessing an authenticated web address via a browser address bar in an embodiment of the invention. As shown in FIG. 9, the method for accessing an authenticated web address via a browser address bar comprises the following processing.

At step 901, an authenticated web address database is queried whether there is an authenticated website matching entry corresponding to all keywords that already exist in the browser address bar when it is detected that the user enters one or more characters to the browser address bar each time.

For example, after the user enters a word “tao” in the browser address bar, the authenticated web address database is automatically queried whether there is an authenticated website matching entry corresponding to the word “tao”, and if no, and it is detected that the user further enters a word “bao”, then the search engine server is automatically queried whether there is an authenticated website matching entry corresponding to “taobao”.

It needs to be noted that in the embodiment of the invention, the authenticated web address database comprises a local database of the browser, and/or a cloud database at the network side.

Step 901 specifically comprises the following processing:

1. triggering invocation of an authenticated web address application programming interface (API for short) of the browser to obtain all keywords that already exist in the browser address bar;

2. according to all the keywords obtained, querying in the local database of the browser whether there is an authenticated website matching entry matching all the keywords that already exist in the browser address bar, and if no, invoking a network data interface to query the cloud database at the network side; and if the matched authenticated website matching entry is found out in the local database of the browser or the cloud database at the network side, obtaining a corresponding web address link in the authenticated website matching entry, wherein the correspondence relationship table comprises keywords, and web address links corresponding to the keywords.

At step 902, if the corresponding authenticated website matching entry is found out, a web address link corresponding to the authenticated website matching entry is obtained from the authenticated web address database, and an interface element corresponding to the web address link is presented at a predetermined position of the browser address bar, wherein the predetermined position comprises: the last position in an input box.

Preferably, in an embodiment of the invention, if website identification information returned by the authenticated web address database is further received, then when displaying the interface element corresponding to the web address link at the predetermined position of the search bar, the interface element corresponding to the web address link can be displayed at the predetermined position of the search bar according to the website identification information.

At step 903, when it is detected that the user triggers the interface element, a request for accessing an authenticated website corresponding to the web address link is initiated.

In the following, the above-described technical solution of embodiments of the invention will be exemplified in connection with the drawings.

### Example Four

### The Keyword is “Taobao”

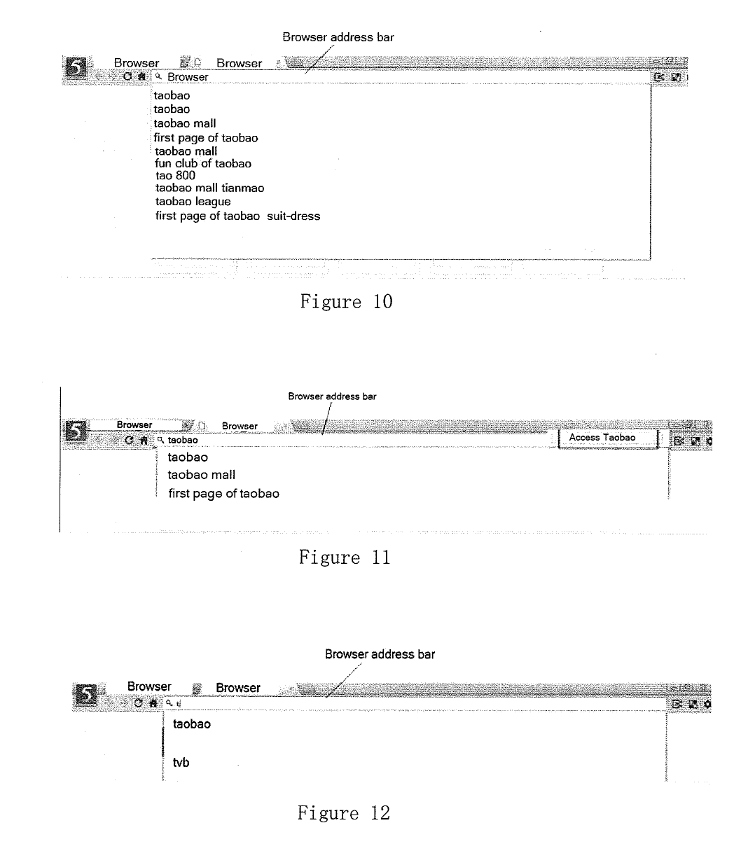

At step 1, as shown in FIG. 10, after it is detected that the user enters a first keyword “tao” in the browser address bar, a backend API is invoked (namely, the keyword is query-converted into a query URL to be sent to the authenticated web address database server: “http://zhidasug.www.so.com) to query a URL: http://zhidasug.www.so.com/?q=% E6%B7%98 (namely, http://zhidasug.www.so.com/?q=tao);

At step 2, the authenticated web address database does not find a match entry corresponding to the keyword “tao”, and therefore the returned jsonp informs a tip that there is no direct access, that is, the returned data is empty: zhida_sug([ ]);

At step 3, after it is detected that the user enters in the browser address bar a second character which combines a keyword “taobao”, a backend API is invoked to send the keyword “taobao” to the authenticated web address database, and the authenticated web address database searches for a corresponding matching entry according to a correspondence relationship table, wherein the correspondence relationship table is as shown in table 2;

TABLE 2

| No. | HOST | URL | Copywriter | Query |
|---|---|---|---|---|
| 1 | Taobao.com | http://www.taobao.com/ | Taobao | Taobao, Taobaowang, |
| | | | | taobao, taobaowang |
| 2 | 360.cn | http://www.360.cn | 360 | 360, qihoo |
| 3 | Tmall.com | http://www.Tmall.com | Tmall | tianmaoshangcheng, |
| | | | | tianmao, tmall |

At step 4, after the authenticated web address database searches the correspondence relationship table, the returned jsonp data packet is zhida_sug([{“u”:“http://www.tmall.com/”,“n”:“u5929\u732b”}]), wherein u represents a direct access url, n represents a copywriter, i.e., displayed name; and taking the keyword “taobao” as an example, the returned jsonp data packet is:

zhida_sug(
[
{
u: “http://www.taobao.com/”,
n: “taobao”
}
]
)

At step 5, as shown in FIG. 11, at this point, a button for direct access is shown at the last position in the browser address bar, and the form of the button is “access <n>”, wherein n is a copywriter, namely, the displayed name “taobao”.

### Example Five

### The Keyword is “Taobao”

At step 1, as shown in FIG. 12, after it is detected that the user enters a first English key letter “t” in the browser address bar, a backend API is invoked (namely, the key letter is query-converted into a query URL to be sent to the authenticated web address database server:“http://zhidasug.www.so.com) to query a URL: http://zhidasug.www.so.com/?q=t;

At step 2, the authenticated web address database does not find a match entry corresponding to the key letter “t”, and therefore the returned jsonp informs a tip that there is no direct access, that is, the returned data is empty: zhida_sug([ ]);

At step 3, after it is detected that the user enters in the browser address bar a second character which combines a keyword “ta”, the backend API is invoked to query a URL, the result fed back by the authenticated web address database at this time is identical to the previous step, and is still empty, until it is detected that the user enters “taobao” in the browser address bar, the backend API is invoked to send the keyword “taobao” to the authenticated web address database, the authenticated web address database searches for a corresponding matching entry according to the correspondence relationship table as shown in table 1, and the returned jsonp data packet is zhida_sug([{“u”:“http://www.taobao.com/”, “n”:“u5929\u732b”}]), wherein u represents a direct access url, n represents a copywriter, i.e., displayed name. Taking the keyword “taobao” as an example, the returned jsonp data packet is:

zhida_sug(
[
- {
u: “http://www.taobao.com/”,
n: “taobao”
}
]
)

At step 4, at this point, a button for direct access is shown at the last position in the browser address bar, and the form of the button is “access <n>”, wherein n is a copywriter, namely, the displayed name “taobao”.

### Example Six

### The Keyword is “Tmall”

At step 1, as shown in FIG. 12, after it is detected that the user enters a first English key letter “t” in the browser address bar, a backend API is invoked (namely, the key letter is query-converted into a query URL to be sent to the authenticated web address database serven“http://zhidasug.www.so.com) to query a URL: http://zhidasug.www.so.com/?q=t;

At step 2, the authenticated web address database does not find a match entry corresponding to the query “t”, and therefore the returned jsonp informs a tip that there is no direct access, that is, the returned data is empty: zhida_sug([ ]);

At step 3, after it is detected that the user enters in the browser address bar a second character which combines a keyword “tm”, the backend API is invoked to query a URL, the result fed back by the authenticated web address database at this time is identical to the previous step, and is still empty, until it is detected that the user enters “tmall” in the browser address bar, the backend API is invoked to send the keyword “tmall” to the authenticated web address database, the authenticated web address database searches for a corresponding matching entry according to the correspondence relationship table as shown in table 1, and the returned jsonp data packet is zhida_sug([{“u”:“http://www.taobao.com/”, “n”:“u5929\u732b”}]), wherein u represents a direct access url, n represents a copywriter, i.e., displayed name. Taking the keyword “tmall” as an example, the returned jsonp data packet is:

zhida_sug(
[
- {
u: “http://www. tmall.com/”,
n: “ tmall ”
}
]
)

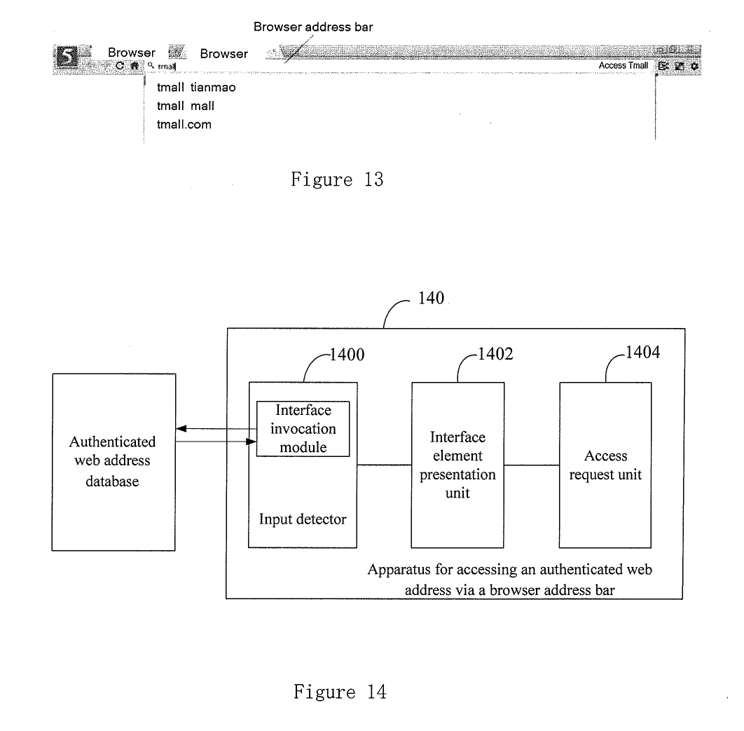

At step 4, as shown in FIG. 13, at this point, a button for direct access is shown at the last position in the browser address bar, and the form of the button is “access <n>”, wherein n is a copywriter, namely, the displayed name “tianmao”.

In summary, by means of the technical solutions of embodiments of the invention, after it is automatically found out that there is an authenticated website matching entry corresponding to all keywords entered by the user, an interface element corresponding to a corresponding web address link is displayed to the user, which reduces the time spent by the user in searching for an official website and provides a fast channel for accessing the authenticated official website for the user.

According to an embodiment of the invention, there is further provided an apparatus for accessing an authenticated web address via a browser address bar. FIG. 14 is a structural diagram of an apparatus for accessing an authenticated web address via a browser address bar in an embodiment of the invention. As shown in FIG. 14, the apparatus 140 for accessing an authenticated web address via a browser address bar according to the embodiment of the invention comprises: an input detector 1400, an interface element presentation unit 1402 and an access request unit 1404, and in the following, each module of the embodiment of the invention will be described in detail.

The input detector 1400 is configured to query an authenticated web address database whether there is an authenticated website matching entry corresponding to all keywords that already exist in the browser address bar when it is detected that the user enters one or more characters to the browser address bar each time.

For example, after detecting that the user enters a word “tao” in the browser address bar, the input detector 1400 automatically queries the authenticated web address database whether there is an authenticated website matching entry corresponding to the word “tao”, and if no, and it is detected that the user further enters a word “bao”, then automatically queries the search engine server whether there is an authenticated website matching entry corresponding to “taobao”.

It needs to be noted that the authenticated web address database comprises a local database of the browser, and/or a cloud database at the network side.

The input detector 1400 specifically comprises an interface invocation module configured to:

1. trigger invocation of an authenticated web address API of the browser to obtain all keywords that already exist in the browser address bar;

2. according to all the keywords obtained, query in the local database of the browser whether there is an authenticated website matching entry matching all the keywords that already exist in the browser address bar, and if no, invoke a network data interface to query the cloud database at the network side; and if the matched authenticated website matching entry is found out in the local database of the browser or the cloud database at the network side, obtain a corresponding web address link in the authenticated website matching entry, wherein the correspondence relationship table comprises keywords, and web address links corresponding to the keywords.

The interface element presentation unit 1402 is configured to, if the corresponding authenticated website matching entry is found out, obtain a web address link corresponding to the authenticated website matching entry from the authenticated web address database, and display an interface element corresponding to the web address link at a predetermined position of the browser address bar, wherein the predetermined position comprises: the last position in an input box.

Optionally, the interface element presentation unit 1402 is further configured to obtain website identification information corresponding to the authenticated website matching entry.

The interface element presentation unit is specifically configured to display the interface element corresponding to the web address link at the predetermined position of the browser address bar according to the website identification information.

The access request unit 1404 is configured to initiate a request for accessing an authenticated website corresponding to the web address link when it is detected that the user triggers the interface element.

The specific processing of each module in the embodiment of the invention can be understood with reference to the description in the above method embodiment, and will not be repeated here.

In summary, by means of the technical solutions of embodiments of the invention, each time after a user enters a character to a browser address bar, and after it is automatically found out that there is an authenticated website matching entry corresponding to all keywords entered by the user, an interface element corresponding to a corresponding web address link is displayed to the user, which reduces the time spent by the user in searching for an official website and provides a fast channel for accessing the authenticated official website for the user.

In the specification provided herein, a plenty of particular details are described. However, it can be appreciated that an embodiment of the invention may be practiced without these particular details. In some embodiments, well known methods, structures and technologies are not illustrated in detail so as not to obscure the understanding of the specification.

Similarly, it shall be appreciated that in order to simplify the disclosure and help the understanding of one or more of all the inventive aspects, in the above description of the exemplary embodiments of the invention, sometimes individual features of the invention are grouped together into a single embodiment, figure or the description thereof. However, the disclosed methods should not be construed as reflecting the following intention, namely, the claimed invention claims more features than those explicitly recited in each claim. More precisely, as reflected in the following claims, an aspect of the invention lies in being less than all the features of individual embodiments disclosed previously. Therefore, the claims complying with a particular implementation are hereby incorporated into the particular implementation, wherein each claim itself acts as an individual embodiment of the invention.

It may be appreciated to those skilled in the art that modules in a device in an embodiment may be changed adaptively and arranged in one or more device different from the embodiment. Modules or units or assemblies may be combined into one module or unit or assembly, and additionally, they may be divided into multiple sub-modules or sub-units or subassemblies. Except that at least some of such features and/or procedures or units are mutually exclusive, all the features disclosed in the specification (including the accompanying claims, abstract and drawings) and all the procedures or units of any method or device disclosed as such may be combined employing any combination. Unless explicitly stated otherwise, each feature disclosed in the specification (including the accompanying claims, abstract and drawings) may be replaced by an alternative feature providing an identical, equal or similar objective.

Furthermore, it can be appreciated to the skilled in the art that although some embodiments described herein comprise some features and not other features comprised in other embodiment, a combination of features of different embodiments is indicative of being within the scope of the invention and forming a different embodiment. For example, in the following claims, any one of the claimed embodiments may be used in any combination.

Embodiments of the individual components of the invention may be implemented in hardware, or in a software module running on one or more processors, or in a combination thereof. It will be appreciated by those skilled in the art that, in practice, some or all of the functions of some or all of the components in an apparatus according to individual embodiments of the invention may be realized using a microprocessor or a digital signal processor (DSP). The invention may also be implemented as a device or apparatus program (e.g., a computer program and a computer program product) for carrying out a part or all of the method as described herein. Such a program implementing the invention may be stored on a computer readable medium, or may be in the form of one or more signals. Such a signal may be obtained by downloading it from an Internet website, or provided on a carrier signal, or provided in any other form.

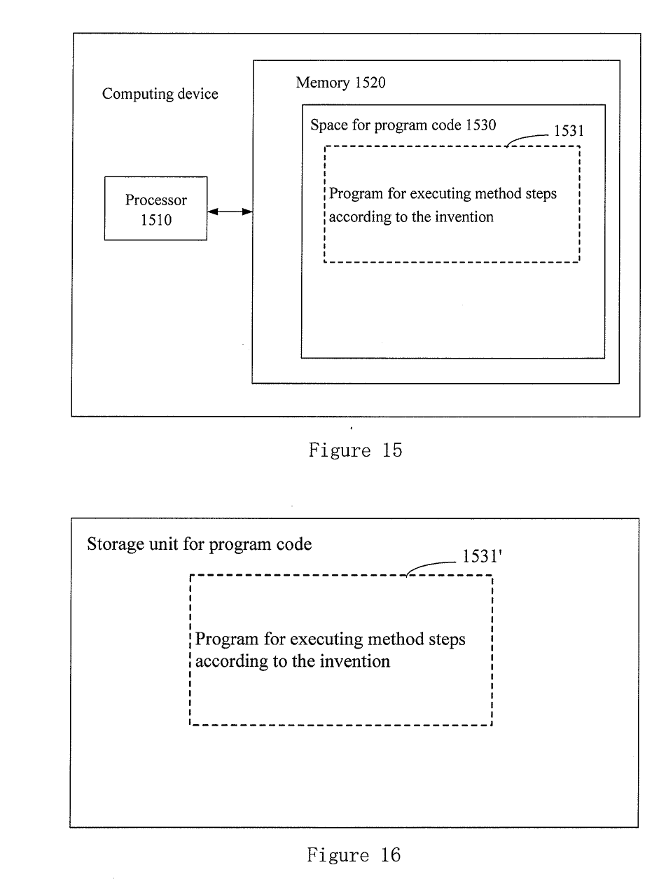

For example, FIG. 15 shows a computing device which may carry out a method for accessing an authenticated web address by a client according to the invention. The computing device traditionally comprises a processor 1510 and a computer program product or a computer readable medium in the form of a memory 1520. The memory 1520 may be an electronic memory such as a flash memory, an EEPROM (electrically erasable programmable read-only memory), an EPROM, a hard disk or a ROM. The memory 1520 has a memory space 1530 for a program code 1531 for carrying out any method steps in the methods as described above. For example, the memory space 1530 for a program code may comprise individual program codes 1531 for carrying out individual steps in the above methods, respectively. The program codes may be read out from or written to one or more computer program products. These computer program products comprise such a program code carrier as a hard disk, a compact disk (CD), a memory card or a floppy disk. Such a computer program product is generally a portable or stationary storage unit as described with reference to FIG. 16. The storage unit may have a memory segment, a memory space, etc. arranged similarly to the memory 1520 in the computing device of FIG. 15. The program code may for example be compressed in an appropriate form. In general, the storage unit comprises a computer readable code 1531′, i.e., a code which may be read by e.g., a processor such as 1510, and when run by a computing device, the codes cause the computing device to carry out individual steps in the methods described above.

“An embodiment”, “the embodiment” or “one or more embodiments” mentioned herein implies that a particular feature, structure or characteristic described in connection with an embodiment is included in at least one embodiment of the invention. In addition, it is to be noted that, examples of a phrase “in an embodiment” herein do not necessarily all refer to one and the same embodiment.

It is to be noted that the above embodiments illustrate rather than limit the invention, and those skilled in the art may design alternative embodiments without departing the scope of the appended claims. In the claims, any reference sign placed between the parentheses shall not be construed as limiting to a claim. The word “comprise” does not exclude the presence of an element or a step not listed in a claim. The word “a” or “an” preceding an element does not exclude the presence of a plurality of such elements. The invention may be implemented by means of a hardware comprising several distinct elements and by means of a suitably programmed computer. In a unit claim enumerating several apparatuses, several of the apparatuses may be embodied by one and the same hardware item. Use of the words first, second, and third, etc. does not mean any ordering. Such words may be construed as naming.

Furthermore, it is also to be noted that the language used in the description is selected mainly for the purpose of readability and teaching, but not selected for explaining or defining the subject matter of the invention. Therefore, for those of ordinary skills in the art, many modifications and variations are apparent without departing the scope and spirit of the appended claims. For the scope of the invention, the disclosure of the invention is illustrative, but not limiting, and the scope of the invention is defined by the appended claims.

1. A method for a client accessing an authenticated web address, comprising:
automatically querying a server or a database whether there is an authenticated website matching entry corresponding to all keywords that the client already has when it is detected that a user enters one or more characters to the client each time;
obtaining a web address link corresponding to the authenticated website matching entry from the server or the database, and displaying an interface element corresponding to the web address link at a predetermined position of the client, if the corresponding authenticated website matching entry is found out; and
accessing the authenticated website corresponding to the web address link when it is detected that the user triggers the interface element.

2. The method as claimed in claim 1, wherein when a character is entered via a search bar of the client,
the automatically querying a server or a database whether there is an authenticated website matching entry corresponding to all keywords that the client already has when it is detected that a user enters one or more characters to the client each time comprises: automatically querying a search engine server whether there is an authenticated website matching entry corresponding to all keywords that already exist in the search bar when it is detected that the user enters one or more characters to the search bar each time; and
the obtaining a web address link corresponding to the authenticated website matching entry from the server or the database, and displaying an interface element corresponding to the web address link at a predetermined position of the client, if the corresponding authenticated website matching entry is found out comprises: if a web address link corresponding to the authenticated website matching entry fed back by the search engine server is received, displaying an interface element corresponding to the web address link at a predetermined position of the search bar.

3. The method as claimed in claim 2, wherein the automatically querying a search engine server whether there is an authenticated website matching entry corresponding to all keywords that already exist in the search bar comprises:
sending all keywords that already exist in the search bar to the search engine server by invoking a preset application programming interface API; and
the search engine server querying whether there is an authenticated website matching entry matching all the keywords that already exist in the search bar in a pre-configured correspondence relationship table, and if no, feeding back a message that there is no authenticated website matching entry; and if yes, obtaining a web address link in the authenticated website matching entry and feeding it back, wherein the correspondence relationship table comprises keywords, and web address links corresponding to the keywords.

4. The method as claimed in claim 2, wherein after automatically querying a search engine server whether there is an authenticated website matching entry corresponding to all keywords that already exist in the search bar, the method further comprises: receiving website identification information returned by the search engine server; and
the displaying an interface element corresponding to the web address link at a predetermined position of the search bar comprises:
displaying the interface element corresponding to the web address link at the predetermined position of the search bar according to the website identification information.

5. The method as claimed in claim 2, wherein the predetermined position comprises: the last position in the search bar.

6. The method as claimed in claim 1, wherein when a character is entered via a browser address bar of the client,
the automatically querying a server or a database whether there is an authenticated website matching entry corresponding to all keywords that the client already has when it is detected that a user enters one or more characters to the client each time comprises: querying an authenticated web address database whether there is an authenticated website matching entry corresponding to all keywords that already exist in the browser address bar when it is detected that the user enters one or more characters to the browser address bar each time; and
the obtaining a web address link corresponding to the authenticated website matching entry from the server or the database, and displaying an interface element corresponding to the web address link at a predetermined position of the client, if the corresponding authenticated website matching entry is found out comprises: if the corresponding authenticated website matching entry is found out, obtaining a web address link corresponding to the authenticated website matching entry from the authenticated web address database, and displaying an interface element corresponding to the web address link at a predetermined position of the browser address bar.

7. The method as claimed in claim 6, wherein the authenticated web address database comprises: a local database of the browser, and/or a cloud database at the network side.

8. The method as claimed in claim 7, wherein the querying an authenticated web address database whether there is an authenticated website matching entry corresponding to all keywords that already exist in the browser address bar comprises:
triggering invocation of an authenticated web address application programming interface API of the browser to obtain all keywords that already exist in the browser address bar; and
according to all the keywords obtained, querying in the local database of the browser whether there is an authenticated website matching entry matching all the keywords that already exist in the browser address bar, and if no, invoking a network data interface to query the cloud database at the network side; and if the matched authenticated website matching entry is found out in the local database of the browser or the cloud database at the network side, obtaining a corresponding web address link in the authenticated website matching entry.

9. The method as claimed in claim 6, wherein after obtaining a web address link corresponding to the authenticated website matching entry, the method further comprises: obtaining website identification information corresponding to the authenticated website matching entry; and
the displaying an interface element corresponding to the web address link at a predetermined position of the browser address bar comprises:
displaying the interface element corresponding to the web address link at the predetermined position of the browser address bar according to the website identification information.

10. A client for accessing an authenticated web address, the client comprising:
a memory having instructions stored thereon;
a processor configured to execute the instructions to perform the following operations:
automatically querying a server or a database whether there is an authenticated website matching entry corresponding to all keywords that the client already has when it is detected that a user enters one or more characters to the client each time;
obtaining a web address link corresponding to the authenticated website matching entry from the server or the database, and displaying an interface element corresponding to the web address link at a predetermined position of the client, if the corresponding authenticated website matching entry is found out; and
accessing the authenticated website corresponding to the web address link when it is detected that the user triggers the interface element.

11. The client as claimed in claim 10, wherein when a character is entered via a search bar of the client,
the automatically querying a server or a database whether there is an authenticated website matching entry corresponding to all keywords that the client already has when it is detected that a user enters one or more characters to the client each time comprises: automatically querying a search engine server whether there is an authenticated website matching entry corresponding to all keywords that already exist in the search bar when it is detected that a user enters one or more characters to the search bar; and
the obtaining a web address link corresponding to the authenticated website matching entry from the server or the database, and displaying an interface element corresponding to the web address link at a predetermined position of the client, if the corresponding authenticated website matching entry is found out comprises: if a web address link corresponding to the authenticated website matching entry fed back by the search engine server is received, displaying an interface element corresponding to the web address link at a predetermined position of the search bar.

12. The client as claimed in claim 11, wherein the automatically querying a search engine server whether there is an authenticated website matching entry corresponding to all keywords that already exist in the search bar comprises:
sending all keywords that already exist in the search bar to the search engine server by invoking a preset application programming interface API; and
the search engine server querying whether there is an authenticated website matching entry matching all the keywords that already exist in the search bar in a pre-configured correspondence relationship table, and if no, feeding back a message that there is no authenticated website matching entry; and if yes, obtaining a web address link in the authenticated website matching entry and feeding it back, wherein the correspondence relationship table comprises keywords, and web address links corresponding to the keywords.

13. The client as claimed in claim 11, wherein after automatically querying a search engine server whether there is an authenticated website matching entry corresponding to all keywords that already exist in the search bar, the operations further comprises: receiving website identification information returned by the search engine server; and
the displaying an interface element corresponding to the web address link at a predetermined position of the search bar comprises:
displaying the interface element corresponding to the web address link at the predetermined position of the search bar according to the website identification information.

14. (canceled)

15. The client as claimed in claim 10, wherein when a character is entered via a browser address bar of the client,
the automatically querying a server or a database whether there is an authenticated website matching entry corresponding to all keywords that the client already has when it is detected that a user enters one or more characters to the client each time comprises: querying an authenticated web address database whether there is an authenticated website matching entry corresponding to all keywords that already exist in the browser address bar when it is detected that the user enters one or more characters to the browser address bar each time; and
the obtaining a web address link corresponding to the authenticated website matching entry from the server or the database, and displaying an interface element corresponding to the web address link at a predetermined position of the client, if the corresponding authenticated website matching entry is found out comprises: if the corresponding authenticated website matching entry is found out, obtaining a web address link corresponding to the authenticated website matching entry from the authenticated web address database, and displaying an interface element corresponding to the web address link at a predetermined position of the browser address bar.

16. The client as claimed in claim 15, wherein the authenticated web address database comprises: a local database of the browser, and/or a cloud database at the network side.

17. The client as claimed in claim 16, wherein the querying an authenticated web address database whether there is an authenticated website matching entry corresponding to all keywords that already exist in the browser address bar comprises:
triggering invocation of an authenticated web address application programming interface API of the browser to obtain all keywords that already exist in the browser address bar; and
according to all the keywords obtained, querying in the local database of the browser whether there is an authenticated website matching entry matching all the keywords that already exist in the browser address bar, and if no, invoking a network data interface to query the cloud database at the network side; and if the matched authenticated website matching entry is found out in the local database of the browser or the cloud database at the network side, obtaining a corresponding web address link in the authenticated website matching entry.

18. The client as claimed in claim 15, wherein after obtaining a web address link corresponding to the authenticated website matching entry, the operations further comprises:
obtaining website identification information corresponding to the authenticated website matching entry; and
the displaying an interface element corresponding to the web address link at a predetermined position of the browser address bar comprises:
displaying the interface element corresponding to the web address link at the predetermined position of the browser address bar according to the website identification information.

19.-21. (canceled)

22. A non-transitory computer readable medium having instructions stored thereon that, when executed by at least one processor, cause the at least one processor to perform operations for a client accessing an authenticated web address, comprising:
automatically querying a server or a database whether there is an authenticated website matching entry corresponding to all keywords that the client already has when it is detected that a user enters one or more characters to the client each time;
obtaining a web address link corresponding to the authenticated website matching entry from the server or the database, and displaying an interface element corresponding to the web address link at a predetermined position of the client, if the corresponding authenticated website matching entry is found out; and
accessing the authenticated website corresponding to the web address link when it is detected that the user triggers the interface element.
